(19) United States
(12) Patent Application Publication
(10) Pub. No.: US 2011/0277936 A1
(43) Pub. Date: Nov. 17, 2011

(54) APPARATUS FOR MANUFACTURING TOUCH PANEL

(75) Inventors: Ho Joon PARK, Seoul (KR); Jong Young LEE, Gyunggi-do (KR); Yong Soo OH, Gyunggi-do (KR)

(73) Assignee: SAMSUNG ELECTRO-MECHANICS CO., LTD., Gyunggi-do (KR)

(21) Appl. No.: 12/841,851

(22) Filed: Jul. 22, 2010

(30) Foreign Application Priority Data
May 14, 2010 (KR) 10-2010-0045434

(51) Int. Cl. B32B 37/02; B05C 11/00; B05C 13/02; B05C 5/00; B05C 11/02

(52) U.S. Cl. 156/387; 118/300; 118/100; 118/66; 118/620; 118/642; 118/35; 118/200

(57) ABSTRACT

Disclosed herein is an apparatus for manufacturing a touch panel, including: a base film supply unit supplying a base film; a first transparent electrode supply unit supplying a first transparent electrode to the base film; a first electrode printing unit printing a first electrode on one side of the base film such that the first electrode is connected with the first transparent electrode; a first adhesive layer supply unit supplying a first adhesive layer to one side of the base film such that the first transparent electrode and the first electrode are coated with the first adhesive layer; a second transparent electrode supply unit supplying a second transparent electrode to the first adhesive layer; a second electrode printing unit printing a second electrode on one side of the first adhesive layer such that the second electrode is connected with the second transparent electrode; and a second adhesive layer supply unit supplying a second adhesive layer to one side of the first adhesive layer such that the second transparent electrode and the second electrode are coated with the second adhesive layer.

### CROSS REFERENCE TO RELATED APPLICATION

This application claims the benefit of Korean Patent Application No. 10-2010-0045434, filed May 14, 2010, entitled “Apparatus for the production of touch panel”, which is hereby incorporated by reference in its entirety into this application.

### BACKGROUND OF THE INVENTION

1. Technical Field

The present invention relates to an apparatus for manufacturing a touch panel.

2. Description of the Related Art

Development of auxiliary computer devices has taken place alongside the advancement of computers which use digital technology. Personal computers, portable transmitters, and other personal information processing apparatuses carry out the processing of text and graphics using input devices such as keyboards, mice and the like.

However, since computers are gradually being used for various purposes alongside the rapid advance of the information society, there is a problem in that it is difficult to efficiently operate the computers using keyboards and mice which serve as input devices. Therefore, the demand to develop an input device which has a simple structure and does not cause erroneous operations and which can be used to easily input information and data by users is increasing.

Further, input devices must have high reliability, high durability, high innovativeness and high workability in addition to general functionality. In order to accomplish these purposes, a touch panel was developed as an input device capable of inputting information such as text, graphics and the like.

The touch panel is mounted on image display apparatuses, such as flat panel displays including electronic notebooks, liquid crystal displays (LCDs), plasma display panels (PDPs), electroluminescence panels, etc., and cathode ray tubes (CRTs), and is used to allow users to select desired information while viewing an image display apparatus.

Touch panels are classified into resistive type touch panels, capacitive type touch panels, electromagnetic type touch panels, surface acoustic wave (SAW) type touch panels, and infrared type touch panels. These various types of touch panels are employed in electronic products in consideration of the problem of signal amplification, the differences of resolution, the difficulty in design and machining techniques, optical characteristics, electrical characteristics, mechanical characteristics, environment-resistant characteristics, input characteristics, durability, and economical efficiency. Currently, among these touch panels, resistive type touch panels and capacitive touch panels are the most widely used.

However, the automation of conventional processes of manufacturing a touch panel has not been possible because of the process of connecting flexible printed cables (FPCs). Therefore, these conventional processes of manufacturing a touch panel are problematic in that complicated assembly processes must be performed, so that a lot of man power must be committed to manufacturing lines and manufacturing costs are increased, thereby decreasing productivity.

### SUMMARY OF THE INVENTION

Accordingly, the present invention has been devised to solve the above-mentioned problems, and the present invention provides an apparatus for manufacturing a touch panel, which can automate the manufacturing process of a touch panel using a roll-type feeder or a sol-type feeder.

Further, the present invention provides an apparatus for manufacturing a touch panel, which can improve the productivity of a touch panel by controlling the speed of rotation of a roll-type feeder.

An aspect of the present invention provides an apparatus for manufacturing a touch panel, including: a base film supply unit supplying a base film; a first transparent electrode supply unit supplying a first transparent electrode to the base film; a first electrode printing unit printing a first electrode on one side of the base film such that the first electrode is connected with the first transparent electrode; a first adhesive layer supply unit supplying a first adhesive layer to one side of the base film such that the first transparent electrode and the first electrode are coated with the first adhesive layer; a second transparent electrode supply unit supplying a second transparent electrode to the first adhesive layer; a second electrode printing unit printing a second electrode on one side of the first adhesive layer such that the second electrode is connected with the second transparent electrode; and a second adhesive layer supply unit supplying a second adhesive layer to one side of the first adhesive layer such that the second transparent electrode and the second electrode are coated with the second adhesive layer.

Here, the apparatus for manufacturing a touch panel may further include: a first coating roll for applying the first transparent electrode supplied from the first transparent electrode supply unit onto one side of the base film; and a second coating roll for applying the second transparent electrode supplied from the second transparent electrode supply unit onto one side of the first adhesive layer.

Further, the apparatus for manufacturing a touch panel may further include: a first protective film supply unit supplying a first protective film to the other side of the base film; and a second protective film supply unit supplying a second protective film to one side of the second adhesive layer.

Further, each of the base film supply unit, the first transparent electrode supply unit, the first adhesive layer supply unit, the second transparent electrode supply unit and the second adhesive layer supply unit may be a roll-type feeder or a sol-type feeder.

Further, each of the first protective film supply unit and the second protective film supply unit may be a roll-type feeder or a sol-type feeder.

Further, the apparatus for manufacturing a touch panel may further include: a first hot-press roll pressing the first adhesive layer onto one side of the base film; and a second hot-press roll pressing the second adhesive layer onto one side of the first adhesive layer.

Further, the apparatus for manufacturing a touch panel may further include: a first drying chamber drying the first transparent electrode; a second drying chamber drying the first electrode; a third drying chamber drying the second transparent electrode; and a fourth drying chamber drying the second electrode.

Further, each of the first drying chamber, the second drying chamber, the third drying chamber and the fourth drying chamber may perform a drying process at 60˜150° C. for 1˜30 minutes.

Further, each of the first drying chamber, the second drying chamber, the third drying chamber and the fourth drying chamber may perform a drying process using thermal drying, UV drying or IR drying.

Further, the first transparent electrode or the second transparent electrode may be made of a conductive polymer.

Further, the conductive polymer may be any one selected from poly-3,4-ethylenedioxythiophene/polystyrenesulfonate (PEDOT/PSS), polyaniline, polyacetylene, and polyphenylenevinylene.

Further, the base film may be made of any one selected from polyethyleneterephthalate (PET), polycarbonate (PC), polymethylmethacrylate (PMMA), polyethylene naphthalate (PEN), polyether sulfone (PES), cyclic olefin copolymer (COC), triacetylcellulose (TAC), polyvinyl alcohol (PVA), polyimide (PI), polystyrene (PS), and K-resin-containing biaxially oriented polystyrene (BOPS).

Further, the apparatus for manufacturing a touch panel may further include: a cutting unit for cutting a predetermined portion of the first adhesive layer or a predetermined portion of the second adhesive layer at a position corresponding to the position at which a flexible printed cable is connected to the predetermined portion thereof.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing an apparatus for manufacturing a touch panel according to an embodiment of the present invention;

FIG. 2 is a plan view showing a touch panel excluding a predetermined portion of a first adhesive layer corresponding to the position at which a flexible printed cable is connected to the predetermined portion thereof; and

FIG. 3 is a plan view showing a touch panel excluding a predetermined portion of a second adhesive layer corresponding to the position at which a flexible printed cable is connected to the predetermined portion thereof.

### DESCRIPTION OF THE PREFERRED EMBODIMENTS

The objects, features and advantages of the present invention will be more clearly understood from the following detailed description of preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

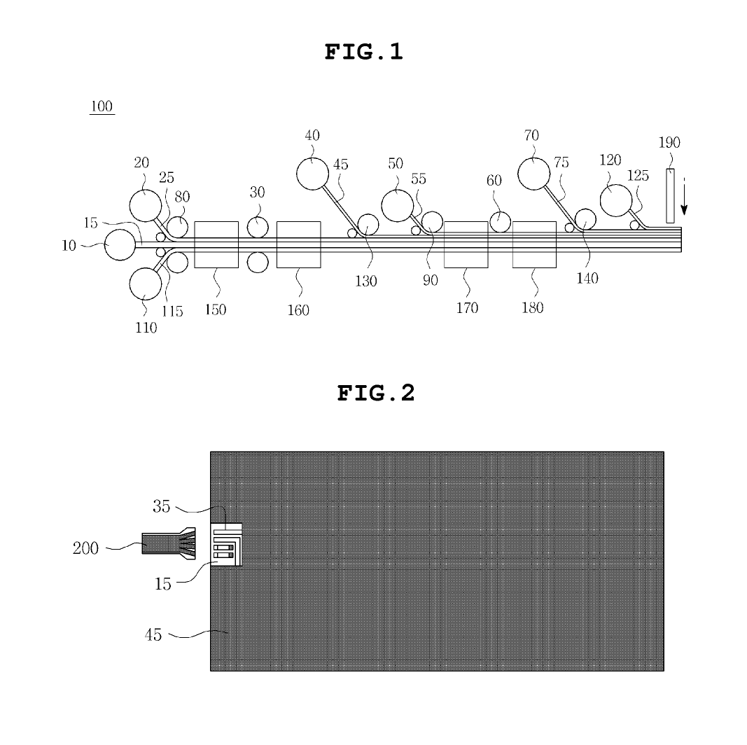

FIG. 1 is a schematic view showing an apparatus for manufacturing a touch panel according to an embodiment of the present invention.

As shown in FIG. 1, the apparatus 100 for manufacturing a touch panel according to this embodiment includes: a base film supply unit 10 supplying a base film 15; a first transparent electrode supply unit 20 supplying a first transparent electrode 25 to the base film 15; a first electrode printing unit 30 printing a first electrode 35 on one side of the base film 15 such that the first electrode 35 is connected with the first transparent electrode 25; a first adhesive layer supply unit 40 supplying a first adhesive layer 45 to one side of the base film 15 such that the first transparent electrode 25 and the first electrode 35 are coated with the first adhesive layer 45; a second transparent electrode supply unit 50 supplying a second transparent electrode 55 to the first adhesive layer 45; a second electrode printing unit 60 printing a second electrode 65 on one side of the first adhesive layer 45 such that the second electrode 65 is connected with the second transparent electrode 55; and a second adhesive layer supply unit 70 supplying a second adhesive layer 75 to one side of the first adhesive layer 45 such that the second transparent electrode 55 and the second electrode 65 are coated with the second adhesive layer 75.

The base film supply unit 10 serves to supply a base film 15 using a roll-type feeder or a sol-type feeder. Here, the base film 15 serves to support a touch panel, and may be made of polyethyleneterephthalate (PET), polycarbonate (PC), polymethylmethacrylate (PMMA), polyethylene naphthalate (PEN), polyether sulfone (PES), cyclic olefin copolymer (COC), triacetylcellulose (TAC), polyvinyl alcohol (PVA), polyimide (PI), polystyrene (PS) or K-resin-containing biaxially oriented polystyrene (BOPS) without limitations.

Meanwhile, the apparatus 100 for manufacturing a touch panel according to this embodiment may include a first protective film supply unit 110 supplying a first protective film 115. Here, the first protective film supply unit 110 supplies a first protective film 115 to the other side (a side opposite to the side to which the first transparent electrode 25 is supplied) of the base film using a roll-type feeder or a sol-type feeder, and the first protective film 115 serves to prevent the base film 15 from being scratched.

The first transparent electrode supply unit 20 serves to supply a first transparent electrode 25 onto the base film 15 using a roll-type feeder or a sol-type feeder. The first transparent electrode 25 supplied from the first transparent electrode supply unit 20 is applied on one side of the base film 15 by a coating roll 80. The first transparent electrode 25 applied on the base film 15 is dried while it passes through a first drying chamber 150. The first drying chamber 150 dries the first transparent electrode 25 at 60˜150° C. for 1˜30 minutes using thermal drying, UV drying or IR drying.

Meanwhile, in order to smoothly supply the first transparent electrode 25 using a roll-type feeder, the first transparent electrode 25 may be made of a conductive polymer having excellent flexibility. Here, examples of the conductive polymer may include poly-3,4-ethylenedioxythiophene/polystyrenesulfonate (PEDOT/PSS), polyaniline, polyacetylene, polyphenylenevinylene, and the like. However, the first transparent electrode 25 may also be made of indium tin oxide (ITO) other than the conductive polymer.

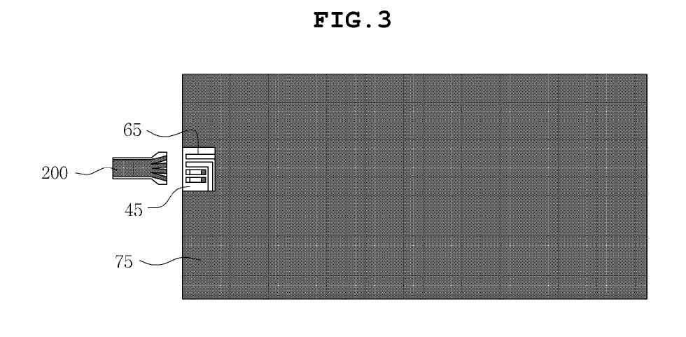

The first electrode printing unit 30 serves to print a first electrode 35 (refer to FIG. 2) on one side of the base film 15 such that the first electrode 35 is connected with the first transparent electrode 25. Here, the first electrode printing unit 30 prints the first electrode 35 using silk screening, gravure printing or ink-jet printing. Further, the first electrode 35 may be made of silver paste or organic silver having excellent electroconductivity, but the raw material of the first electrode 35 is not limited thereto. The raw materials of the first electrode 35 may include conductive polymers, carbon black (including CNT), metal oxides (for example, ITO), low-resistance metals, and the like. Meanwhile, the printed first electrode 35 is dried while passing through a second drying chamber 160. The second drying chamber 160, similarly to the first drying chamber 150, dries the first electrode 35 at 60˜150° C. for 1˜30 minutes using thermal drying, UV drying or IR drying.

The first adhesive layer supply unit 40 serves to supply a first adhesive layer 45 to one side of the base film 15 such that the first transparent electrode 25 and the first electrode 35 are coated with the first adhesive layer 45, and the first adhesive layer 45 is supplied by a roll-type feeder or a sol-type feeder. The supplied first adhesive layer 45 is pressed on one side of the base film 15 by a first hot-press roll 130. Here, the first adhesive layer 45 may be formed of optical clear adhesive (OCA) or double adhesive tape (DAT), but the present invention is not limited thereto.

The second transparent electrode supply unit 50 serves to supply a second transparent electrode 55 to the first adhesive layer 45, and the second transparent electrode 55 is supplied by a roll-type feeder or a sol-type feeder. The second transparent electrode 55 supplied from the second transparent electrode supply unit 50 is applied on one side of the first adhesive layer 45 by a second coating roll 90. Further, the second transparent electrode 55 applied on the first adhesive layer 45 is dried while passing through a third drying chamber 170. The third drying chamber dries the second transparent electrode 55 in the same condition and manner as the first drying chamber 150.

Meanwhile, the second transparent electrode 55, like the first transparent electrode 25, may be made of a conductive polymer having excellent flexibility, and examples of the conductive polymer may include poly-3,4-ethylenedioxythiophene/polystyrenesulfonate (PEDOT/PSS), polyaniline, polyacetylene, polyphenylenevinylene, and the like.

The second electrode printing unit 60 serves to print a second electrode 65 (refer to FIG. 3) on one side of the first adhesive layer 45 such that the second electrode 65 is connected with the second transparent electrode 55. Here, the second electrode printing unit 60 can print the second electrode 65 in the same manner as the first electrode printing unit 30. Meanwhile, the printed second electrode 65 is dried while passing through a fourth drying chamber 180, and the fourth drying chamber 180 dries the second electrode 65 in the same condition and manner as the second drying chamber 160.

The second adhesive layer supply unit 70 serves to supply a second adhesive layer 75 to one side of the first adhesive layer 45 such that the second transparent electrode 55 and the second electrode 65 are coated with the second adhesive layer 75, and the second adhesive layer 75 is supplied by a roll-type feeder or a sol-type feed. The supplied second adhesive layer 75 is pressed on one side of the first adhesive layer 45 by a second hot-press roll 140. Here, the second adhesive layer 75 may be formed of optical clear adhesive (OCA) or double adhesive tape (DAT), but the present invention is not limited thereto.

Meanwhile, the apparatus 100 for manufacturing a touch panel according to this embodiment may include a second protective film supply unit 120 supplying a second protective film 125. Here, the second protective film supply unit 120 supplies a second protective film 125 to one side of the second adhesive layer 75 using a roll-type feeder or a sol-type feeder, and the second protective film 125 serves to prevent the second adhesive layer 75 from being scratched.

The apparatus 100 for manufacturing a touch panel according to this embodiment continuously produces a touch panel using a roll to roll manner in which major components of the touch panel are supplied by a roll-type feeder or a sol-type feeder. Therefore, the apparatus 100 for manufacturing a touch panel may further include a touch panel dividing unit 190 for dividing the produced touch panel.

FIG. 2 is a plan view showing a touch panel excluding a predetermined portion of a first adhesive layer corresponding to the position at which a flexible printed cable is connected to the predetermined portion thereof, and FIG. 3 is a plan view showing a touch panel excluding a predetermined portion of a second adhesive layer corresponding to the position at which a flexible printed cable is connected to the predetermined portion thereof.

As shown in FIGS. 2 and 3, since the first electrode 35 coated with the first adhesive layer 45 or the second electrode 65 coated with the second adhesive layer 75 must be finally connected with a flexible printed cable 200, the apparatus 100 for manufacturing a touch panel may further include a cutting unit for cutting a predetermined portion (refer to FIG. 2) of the first adhesive layer 45 or a predetermined portion (refer to FIG. 3) of the second adhesive layer 75 corresponding to the position at which the flexible printed cable 200 is connected to the predetermined portion thereof.

Since the apparatus 100 for manufacturing a touch panel according to this embodiment supplies the base film 15, the first transparent electrode 25, the second transparent electrode 55, the first adhesive layer 45, the second adhesive layer 75 and the like using a roll-type feeder or a sol-type feeder, the manufacturing process of the touch panel can be automated, thus reducing the manufacturing cost thereof. Further, the apparatus 100 for manufacturing a touch panel can improve the productivity of the touch panel by controlling the speed of rotation of a roll-type feeder.

As described above, according to the present invention, since the process of manufacturing a touch panel is automated by a roll-type feeder or a sol-type feeder, the manufacturing cost of the touch panel can be reduced, and the manufacturing period thereof can be shortened.

Further, according to the present invention, the productivity of the touch panel can be improved by controlling the speed of rotation of a roll-type feeder.

Furthermore, according to the present invention, a touch panel can be manufactured in a roll to roll manner because components constituting the touch panel are continuously supplied.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention, and the specific scope of the present invention will be clearly defined by the appended claims.

What is claimed is:

1. An apparatus for manufacturing a touch panel, comprising:
a base film supply unit supplying a base film;
a first transparent electrode supply unit supplying a first transparent electrode to the base film;
a first electrode printing unit printing a first electrode on one side of the base film such that the first electrode is connected with the first transparent electrode;
a first adhesive layer supply unit supplying a first adhesive layer to one side of the base film such that the first transparent electrode and the first electrode are coated with the first adhesive layer;
a second transparent electrode supply unit supplying a second transparent electrode to the first adhesive layer;
a second electrode printing unit printing a second electrode on one side of the first adhesive layer such that the second electrode is connected with the second transparent electrode; and
a second adhesive layer supply unit supplying a second adhesive layer to one side of the first adhesive layer such that the second transparent electrode and the second electrode are coated with the second adhesive layer.

2. The apparatus for manufacturing a touch panel according to claim 1, further comprising:
a first coating roll for applying the first transparent electrode supplied from the first transparent electrode supply unit onto one side of the base film; and
a second coating roll for applying the second transparent electrode supplied from the second transparent electrode supply unit onto one side of the first adhesive layer.

3. The apparatus for manufacturing a touch panel according to claim 1, further comprising:
a first protective film supply unit supplying a first protective film to the other side of the base film; and
a second protective film supply unit supplying a second protective film to one side of the second adhesive layer.

4. The apparatus for manufacturing a touch panel according to claim 1, wherein each of the base film supply unit, the first transparent electrode supply unit, the first adhesive layer supply unit, the second transparent electrode supply unit and the second adhesive layer supply unit is a roll-type feeder or a sol-type feeder.

5. The apparatus for manufacturing a touch panel according to claim 3, wherein each of the first protective film supply unit and the second protective film supply unit is a roll-type feeder or a sol-type feeder.

6. The apparatus for manufacturing a touch panel according to claim 1, further comprising:
a first hot-press roll pressing the first adhesive layer onto one side of the base film; and
a second hot-press roll pressing the second adhesive layer onto one side of the first adhesive layer.

7. The apparatus for manufacturing a touch panel according to claim 1, further comprising:
a first drying chamber drying the first transparent electrode;
a second drying chamber drying the first electrode;
a third drying chamber drying the second transparent electrode; and
a fourth drying chamber drying the second electrode.

8. The apparatus for manufacturing a touch panel according to claim 7, wherein each of the first drying chamber, the second drying chamber, the third drying chamber and the fourth drying chamber performs a drying process at 60˜150° C. for 1˜30 minutes.

9. The apparatus for manufacturing a touch panel according to claim 7, wherein each of the first drying chamber, the second drying chamber, the third drying chamber and the fourth drying chamber performs a drying process using thermal drying, UV drying or IR drying.

10. The apparatus for manufacturing a touch panel according to claim 1, wherein the first transparent electrode or the second transparent electrode is made of a conductive polymer.

11. The apparatus for manufacturing a touch panel according to claim 10, wherein the conductive polymer is any one selected from poly-3,4-ethylenedioxythiophene/polystyrenesulfonate (PEDOT/PSS), polyaniline, polyacetylene, and polyphenylenevinylene.

12. The apparatus for manufacturing a touch panel according to claim 1, wherein the base film is made of any one selected from polyethyleneterephthalate (PET), polycarbonate (PC), polymethylmethacrylate (PMMA), polyethylene naphthalate (PEN), polyether sulfone (PES), cyclic olefin copolymer (COC), triacetylcellulose (TAC), polyvinyl alcohol (PVA), polyimide (PI), polystyrene (PS), and K-resin-containing biaxially oriented polystyrene (BOPS).

13. The apparatus for manufacturing a touch panel according to claim 1, further comprising:
a cutting unit for cutting a predetermined portion of the first adhesive layer or a predetermined portion of the second adhesive layer at a position corresponding to the position at which a flexible printed cable is connected to the predetermined portion thereof.
